(19) United States
(12) Patent Application Publication
(10) Pub. No.: US 2025/0338358 A1
(43) Pub. Date: Oct. 30, 2025

(54) MULTILAYER HEATING FILM AND METHOD FOR PRODUCING A MULTILAYER HEATING FILM

(71) Applicant: Marelli Germany GmbH, Baden-Württemberg (DE)

(72) Inventors: Martina SAUER-OBERSCHELP, Kirchheim unter Teck (DE); Uwe SCHUBERT, Plochingen (DE)

(21) Appl. No.: 19/186,161

(22) Filed: Apr. 22, 2025

(30) Foreign Application Priority Data
Apr. 24, 2024 (DE) 102024111549.1

(51) Int. Cl. H05B 3/28; F21S 45/60; H05B 3/00

(52) U.S. Cl. CPC H05B 3/286; F21S 45/60; H05B 3/0019

(57) ABSTRACT

A heating film for a motor vehicle, comprising at least one first heating circuit layer having at least one first heating circuit and at least one second heating circuit layer formed separately from the first heating circuit layer and having at least one second heating circuit, wherein the at least one first heating circuit and the at least one second heating circuit are electrically connected in parallel.

### CROSS-REFERENCE TO RELATED APPLICATIONS

This application claims priority pursuant to 35 U.S.C. 119 (a) to German Patent Application No. 102024111549.1, filed Apr. 24, 2024, which application is incorporated herein by reference in its entirety.

### BACKGROUND

EP 1 646 266 A2 discloses a heating element for front modules or bumpers of a motor vehicle, having a single heating circuit layer.

### SUMMARY OF THE INVENTION

The object addressed by the invention is that of providing a flexible and easily maintainable heating film.

The object addressed by the invention is achieved by a heating film for a cover lens of a headlight and/or a front module and/or a bumper and/or a radome of a motor vehicle having the features of claim 1. The heating film comprises at least one first heating circuit layer having at least one first heating circuit and at least one second heating circuit layer that is formed separately from the first heating circuit layer and has at least one second heating circuit, wherein the at least one first heating circuit and the at least one second heating circuit are electrically connected in parallel.

Due to a plurality of heating circuit layers, greater flexibility is provided with respect to the design, arrangement, and formation of the heating circuits. Accordingly, the heating circuits, in particular their conducting tracks, can be wider in the film plane. If fewer conducting tracks are to be provided, they can be wider so as to ensure consistent electrical resistance. The electrical parallel connection between the heating circuits provides a simple way of configuring the resistance of the heating circuits.

It is advantageous if the at least one first heating circuit layer and/or the at least one second heating circuit layer extend(s) in parallel with a planar or three-dimensional film plane. Accordingly, the heating film can be specifically adapted or integrally molded on the shape of a front module and/or a bumper of a motor vehicle.

For the purposes of the invention, a “three-dimensional film plane” may be understood to mean a film plane which is curved at least in portions and/or has protruding and/or recessed regions and thus deviates from a completely planar design.

It is further advantageous if the at least one first heating circuit layer and the at least one second heating circuit layer are spaced apart from one another and/or stacked along a longitudinal axis, wherein the longitudinal axis is transverse, in particular, perpendicular to the film plane. Accordingly, a multi-layer heating film is easy to produce. The longitudinal axis preferably runs perpendicularly to the film plane if the film plane is planar or if the three-dimensionally deformed heating film has been integrally molded on a planar surface.

An advantageous development of the invention provides that the at least one first heating circuit be arranged on the at least one first heating circuit layer, and/or the at least one second heating circuit be arranged on the at least one second heating circuit layer, and/or the at least one first heating circuit layer and the at least one second heating circuit layer be arranged relative to one another, such that the at least one first heating circuit and the at least one second heating circuit are offset from one another, in particular along the longitudinal axis. Consequently, there are at least portions of a heating circuit, in particular a conducting track, that do not lie on another heating circuit, in particular a conducting track. Preferably, the heating circuits, in particular the conducting tracks, are arranged in a zigzag shape along the longitudinal axis. This prevents any electrical contact between the heating circuits.

It is advantageous if at least one connection point is provided for coupling to a power supply. The at least one connection point is preferably electrically connected to at least one heating circuit. Preferably, at least one connection point, in particular two connection points, is/are provided for each heating circuit layer and/or each heating circuit. Consequently, the heating film is easy to put into operation.

It is also advantageous if one film is provided for each heating circuit layer. Accordingly, each heating circuit layer is embedded in a separate film, or each heating circuit is applied to a separate film. This allows easy handling of the heating circuit layers. Accordingly, the individual heating circuit layers can be applied to and produced on the films in advance and then joined together. Preferably, the at least one first heating circuit layer is applied to at least one first film, and/or the at least one second heating circuit layer is applied to at least one second film.

The heating film, in particular the first film and/or the second film and/or the substrate for the first heating circuit layer and/or for the second heating circuit layer, is/are preferably made of a polycarbonate (PC) and/or polybutylene terephthalate (PBT) and/or of a cross-linked polyethylene (PEX) and/or polymethyl methacrylate (PMMA). The material of the heating film is preferably matched to the material of the front-end bumper module made of polymer material.

A further advantageous development of the invention provides that at least one insulation layer be arranged between two adjacent heating circuit layers, in particular between the at least one first heating circuit layer and the at least one second heating circuit layer. The insulation layer is preferably an electrically insulating layer. The insulation layer preferably prevents two adjacent heating circuit layers from coming into contact. Accordingly, thin heating films having a plurality of heating circuit layers can be provided.

It is advantageous if the at least one first heating circuit and the at least one second heating circuit have at least one conducting track, in particular a plurality of conducting tracks electrically connected in parallel. The at least one conducting track is preferably made of an electrically conductive printing paste and/or a copper wire. The printing paste is preferably applied using screen printing or pad printing. A printing paste usually has a lower degree of electrical conductivity than copper wires. In order to achieve similar electrical resistance to the copper wires, a plurality of conducting tracks made of printing paste must be applied. Fault detection is difficult to achieve with a plurality of conducting tracks because a failure results in only a small change in resistance. Due to the multi-layered structure of the heating film, it is not necessary to provide a plurality of conducting tracks made of printing paste. In order to still achieve an appropriate degree of electrical resistance, wider conducting tracks made of printing paste can be applied. The larger surface extent required for this is achieved by providing a plurality of heating circuit layers. Furthermore, printed heating circuits and/or conducting tracks are more elastic than those made of copper wires, which is particularly advantageous for the subsequent three-dimensional deformation of the heating film. During subsequent deformation, the printing paste means that the heating circuits and/or the conducting tracks do not break, wrinkle, and/or crack.

Preferably, conducting tracks made of printed circuits and wired circuits, in particular wire or strip-shaped material, can also be combined. In this case, it is conceivable that different manufacturing processes be combined, e.g., the surface be produced as a pad-printed product and the lines around the corners be produced by wiring.

It is advantageous if printing pastes are designed in such a way that they have negative temperature coefficient properties (NTC properties). This makes it possible to limit the extent to which the conducting tracks heat up.

It is further advantageous if the conducting track extending in parallel with the film plane has a width of up to 20 mm, in particular 5 mm. Preferably, the width of the conducting track is in a range between 10 μm and 1,000 μm, preferably between 20 μm and 500 μm. Consequently, a suitable degree of electrical resistance is guaranteed. It is also advantageous for the height of the conducting track extending perpendicularly to the film plane to be in a range between 10 μm and 40 μm. Such small heights require the conducting tracks to have a corresponding width.

The heating film preferably has a total of two to ten, in particular two to six, preferably two to four, heating circuits. Consequently, faults are easier to detect. Due to the small number of heating circuits, failure of a conducting track and/or heating circuit causes a significant change in resistance. In the prior art, this is not possible with printed heating circuits, since a plurality of heating circuits or conducting tracks, in particular 30 to 40, were required to achieve adequate electrical resistance. If a failure occurs in this case, it causes only a small change in resistance, which cannot be recorded or is difficult to record.

A further advantageous development provides that the at least one sensor element connected to the at least one first heating circuit and/or to the at least one second heating circuit be provided for recording a failure of one or more heating circuits, in particular one or more conducting tracks. Due to the increased flexibility, the sensor element can be easily arranged on the heating film, in particular the at least one first heating circuit layer and/or the at least one second heating circuit layer.

Preferably, a temperature sensor is provided for recording the temperature in the first heating circuit layer and/or the second heating circuit layer.

The object addressed by the invention is also achieved by a method for producing a heating film, in particular as described above. The method involves the following steps, preferably in letter order:
a) providing a film,
b) applying a printing paste to the film to produce a first heating circuit layer having a first heating circuit,
c) curing the first heating circuit layer,
d) applying an insulation layer to the first heating circuit layer,
e) curing the insulation layer,
f) applying a printing paste to the insulation layer to produce a second heating circuit layer having a second heating circuit, and,
g) curing the second heating circuit layer.

It is advantageous if a colorant is additionally applied, in particular in a printing method, before and/or during and/or after the application of a printing paste according to step b) and/or step f), and/or before and/or during and/or after the application of an insulating layer according to step d). Accordingly, an elastic and colored heating circuit layer can be produced in one method step or in one production line. Preferably, the printing paste and the colorant are applied using the same printing method.

It is further advantageous if the film is three-dimensionally deformed, in particular integrally molded on a front module and/or a bumper of a motor vehicle, before the provision thereof according to step a), and/or before and/or during and/or after the application of the first heating circuit layer according to step b), and/or before and/or during and/or after the application of the insulation layer according to step d), and/or before and/or during and/or after the application of the second heating circuit layer according to step f). The heating film can therefore be easily and safely adapted to the element to be heated.

Preferably, a connection point for coupling to a power supply is attached before and/or during and/or after the application of the first heating circuit layer according to step b), and/or before and/or during and/or after the application of the second heating circuit layer according to step f).

Advantageously, at least one sensor element for recording a failure of one or more heating circuits is attached before and/or during and/or after the application of the first heating circuit layer according to step b), and/or before and/or during and/or after the application of the second heating circuit layer according to step f).

Part of the description relates to a front panel and/or to a front bumper and/or to a radome having a heating film as described previously.

Part of the description also relates to a motor vehicle having a heating film as described previously.

Further details and advantageous embodiments of the invention can be found in the following description, on the basis of which exemplary embodiments of the invention are described and explained further.

### IN THE DRAWINGS

FIG. 1 shows a front panel of a motor vehicle having a heating film;

FIG. 2 is a schematic front view of a first embodiment of a heating film;

FIG. 3 is a schematic front view of a second embodiment of a heating film;

FIG. 4 is a schematic side view of the heating film according to FIG. 3; and,

FIG. 5 is a schematic view of a method for producing a heating film.

### DETAILED DESCRIPTION OF THE INVENTION

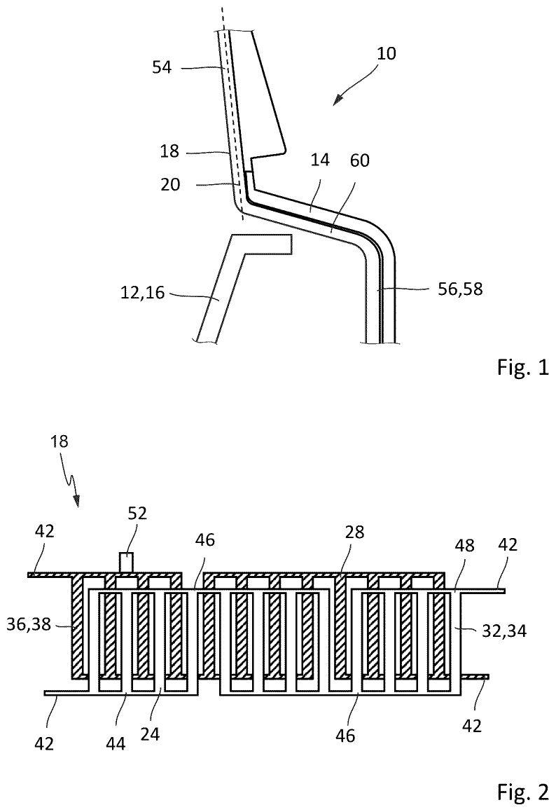

According to FIG. 1, a headlight 10 of a vehicle 12 has a cover lens 14 which is integrally molded on a bumper 16 and/or on a hood (not shown). Sensors (not shown), in particular for a vehicle assistance system, are provided in the headlight 10. To ensure that the sensors also function in winter, a heater is provided in or on the cover lens 14. The heater can additionally or alternatively also be arranged on a front module and/or on the bumper 16 and/or a radome.

The heater is provided by a heating film 18. According to FIG. 1, the heating film 18 is preferably integrally molded on the cover lens 14 and is thus three-dimensional.

According to FIG. 4, the heating film 18 has a film 22 extending along a planar film plane 20. A first heating circuit layer 24 running in parallel with the film plane 20 is arranged on the film 22. An insulation layer 26 running in parallel with the film plane 20 is preferably arranged on the first heating circuit layer 24. A second heating circuit layer 28 running in parallel with the film plane 20 is arranged on the insulation layer 26. Accordingly, the film 22, the first heating circuit layer 24, the insulation layer 26, and the second heating circuit layer 28 are spaced apart from one another and/or stacked along a longitudinal axis 30 running perpendicularly to the film plane 20.

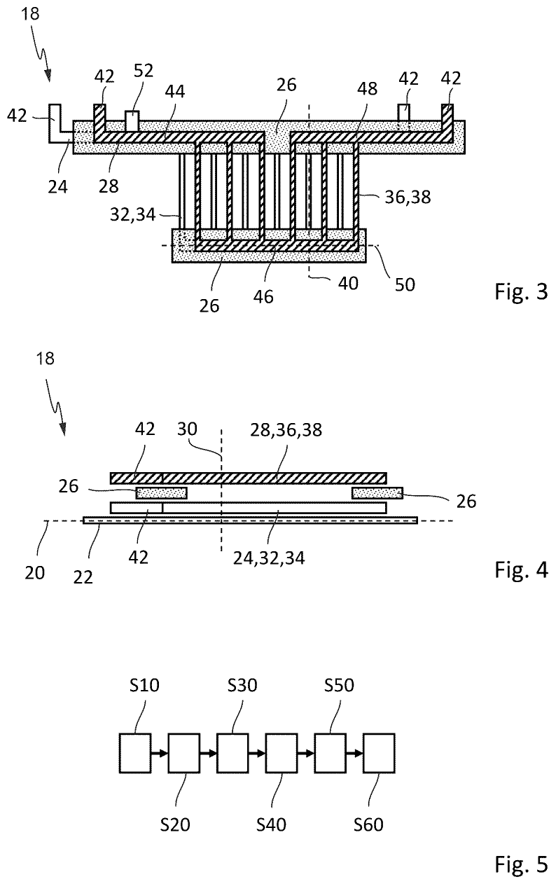

According to FIG. 3, the first heating circuit layer 24 has a first heating circuit 32 with six first conducting tracks 34. The second heating circuit layer 28 has a second heating circuit 36 with six second conducting tracks 38. An electrically conductive printing paste is printed onto the first conducting tracks 34 and the second conducting tracks 38, which run in parallel with a track axis 40. The track axis 40 preferably runs in parallel with the film plane 20. The insulation layer 26 is an electrically insulating layer and provides electrical separation between the first heating circuit layer 24 and the second heating circuit layer 28.

The first conducting tracks 34 and the second conducting tracks 38 are electrically connected in parallel. The first heating circuit 32 and the second heating circuit 36 are also electrically connected in parallel. The first heating circuit 32 and the second heating circuit 36 can be connected by means of connection points 42 to a power supply (not shown), preferably via the motor vehicle's on-board power supply.

According to FIGS. 2 and 3, the first heating circuit 32 and the second heating circuit 36 are each arranged in the first heating circuit layer 24 and in the second heating circuit layer 28, respectively, such that the first heating circuit 32, in particular the first conducting tracks 34, and the second heating circuit 36, in particular the second conducting tracks 38, are offset from one another along the longitudinal axis 30. Accordingly, the first conducting tracks 34 and the second conducting tracks 38 are offset from one another and therefore do not lie on top of one another.

According to FIG. 3, the first heating circuit 32 and the second heating circuit 36 have an upper first heating portion 44, a lower second heating portion 46, and an upper third heating portion 48, wherein the first heating portion 44 and the third heating portion 48 are each connected to a connection point 42. The first heating portion 44 is electrically connected to the second heating portion 46 by means of three first conducting tracks 34. The second heating portion 46 is connected to the third heating portion 48 by means of three further first conducting tracks 34. The same also applies to the second heating circuit layer 28. The first heating portion 44, the second heating portion 46, and the third heating portion 48 preferably run along a portion axis 50 in parallel with the film plane 20. In FIG. 3, the first heating circuit 32 is only partially visible, since it is covered by the insulation layer 26 and by the second heating circuit 36.

FIG. 2 also shows a heating film 18 having a first heating circuit layer 24 and a second heating circuit layer 28, wherein an insulation layer 26 is not provided and/or shown here. The first heating circuit layer 24 has 12 first conducting tracks 34, and the second heating circuit layer 28 has 12 second conducting tracks 38. According to FIG. 3, first heating portions 44, second heating portions 46, and third heating portions 48 are also provided here, wherein the first heating portions 44 and the third heating portions 48 are each connected to connection points 42.

Furthermore, according to FIGS. 2 to 4, a sensor element 52 is provided for each first heating circuit 32 and second heating circuit 36 to record a failure of a heating circuit 32, 36 or a conducting track 34, 38.

A method for producing the heating film 18 is shown in FIG. 5. Accordingly, a film 22 is provided (S10). A printing paste is applied to or printed onto the film 22 to produce a first heating circuit layer 24 having a first heating circuit 32, in particular using screen printing. The heating film 18 then rests until the first heating circuit layer 24 has cured (S20). An insulation layer 26 is printed onto the cured first heating circuit layer 24 (S30). The heating film 18 then rests until the insulation layer 26 has cured (S40). The second heating circuit layer 28 having the second heating circuit 36 is printed onto the cured insulation layer 26 (S50). The heating film 18 then rests until the second heating circuit layer 28 has cured (S60). Preferably, when applying the first heating circuit layer 24 and/or the insulation layer 26 and/or the second heating circuit layer 28, a colorant can be applied for coloring the heating film 18. Furthermore, it is advantageous if for each heating circuit layer 24, 28 two connection points 42 are provided for coupling to a power supply (not shown). It is also advantageous if a sensor element 52 is provided for each heating circuit layer 24, 28.

Subsequently, the heating film 18 running in parallel with the film plane 20 is three-dimensionally deformed, such that it is integrally molded, for example, on a cover lens 14 of a headlight 10. After deformation, the film plane 20 is partially or completely curved. The three-dimensionally deformed heating film 18 has a first film region 54 and a second film region 56. The first film region 54 preferably continues to extend in parallel with the film plane 20. The second film region 56 deviates from the film plane 20, in particular protrudes or is recessed with respect to the film plane 20. The second film region 56 may preferably be formed as a raised portion or pocket. The second film region 56 is further divided into a planar flat region 58 and a projection 60, wherein the projection 60 is formed by the edge region, adjacent to the first film region 54, of the second film region 56. Particularly in the region of the projection 60, the first conducting tracks 34 and the second conducting tracks 38 are exposed to considerable deformations, which lead to the conducting tracks wrinkling and breaking if they are made of copper wires. Conductor tracks 34, 38 made of printing paste are considerably more elastic and are therefore suitable for subsequent deformation. Due to the multi-layer structure, the higher degree of electrical resistance of the conducting tracks 34, 38 made of printing paste compared to copper wires can be compensated for by wide conducting tracks 34, 38. Furthermore, the number of conducting tracks 34, 38 can thereby be reduced, which enables easier diagnosis of errors by means of the sensor element 52.

It is also conceivable for the heating film 18 to have three, four, five, or six heating circuit layers 24, 28.

1. A heating film for a motor vehicle, comprising:
at least one first heating circuit layer having at least one first heating circuit,
at least one second heating circuit layer formed separately from the first heating circuit layer and having at least one second heating circuit, wherein the at least one first heating circuit and the at least one second heating circuit are electrically connected in parallel.

2. The heating film according to claim 1, wherein the at least one first heating circuit layer and/or the at least one second heating circuit layer extend in parallel with a planar or three-dimensional film plane.

3. The heating film according to claim 2, wherein the at least one first heating circuit layer and the at least one second heating circuit layer are stacked along a longitudinal axis, wherein the longitudinal axis is transverse, in particular, perpendicular to the film plane.

4. The heating film according to claim 1, wherein the at least one first heating circuit is arranged on the at least one first heating circuit layer, and/or the at least one second heating circuit is arranged on the at least one second heating circuit layer, such that the at least one first heating circuit and/or the at least one second heating circuit are offset from one another.

5. The heating film according to claim 1, wherein at least one connection point for coupling to a power supply is provided for each heating circuit layer.

6. The heating film according to claim 1, wherein at least one insulation layer is arranged between two adjacent heating circuit layers.

7. The heating film according to claim 1, wherein the at least one first heating circuit and the at least one second heating circuit have at least one conducting track, in particular made of an electrically conductive printing paste and/or a copper wire.

8. The heating film according to claim 7, wherein the width of the at least one conducting track is in a range between 10 μm and 20 mm, in particular between 20 μm and 500 μm.

9. The heating film according to claim 1, wherein a total of two to ten, in particular two to six, preferably two to four, heating circuits are provided.

10. The heating film according to claim 1, wherein at least one sensor element connected to the at least one first heating circuit and/or to the at least one second heating circuit is provided for recording a failure of one or more heating circuits.

11. A method for producing a heating film, in particular according to claim 1, comprising the following steps:
a) providing a film,
b) applying a printing paste to the film to produce a first heating circuit layer having a first heating circuit,
c) curing the first heating circuit layer,
d) applying an insulation layer to the first heating circuit layer,
e) curing the insulation layer,
f) applying a printing paste to the insulation layer to produce a second heating circuit layer having a second heating circuit, and,
g) curing the second heating circuit layer.

12. The method according to claim 11, wherein a colorant is additionally applied before and/or during and/or after the application of a printing paste according to step b) and/or step f) and/or before and/or during and/or after the application of an insulating layer according to step d).

13. The method according to claim 11, wherein, before the provision of the film according to step a) and/or before and/or during and/or after the application of the first heating circuit layer according to step b) and/or before and/or during and/or after the application of the insulation layer according to step d) and/or before and/or during and/or after the application of the second heating circuit layer according to step f), said film is three-dimensionally deformed, in particular integrally molded on a cover lens of a headlight and/or radome and/or a front module and/or a bumper of a motor vehicle.

14. The method according to claim 11, wherein a connection point for coupling to a power supply is attached before and/or during and/or after the application of the first heating circuit layer according to step b) and/or before and/or during and/or after the application of the second heating circuit layer according to step f).

15. The method according to claim 11, wherein at least one sensor element for recording a failure of one or more heating circuits is attached before and/or during and/or after the application of the first heating circuit layer according to step b) and/or before and/or during and/or after the application of the second heating circuit layer according to step f).
